(19) United States
(12) Patent Application Publication
(10) Pub. No.: US 2007/0119200 A1
(43) Pub. Date: May 31, 2007

(54) Beverage cooling device

(76) Inventor: Oluwafemi Ajibola Afolabi, Mississauga (CA)

Correspondence Address: OLUWAFEMI A. AFOLABI, SUITE 33, 119 BRISTOL ROAD EAST, MISSISSAUGA, ON, L4Z 3P7, CA

(21) Appl. No.: 11/286,977

(22) Filed: Nov. 28, 2005

(51) Int. Cl. F28D 5/00; F25D 3/08; F17C 13/00

(52) U.S. Cl. 62/304; 62/457.3; 62/457.9

(57) ABSTRACT

The releaser is used in a specialized freezer tray to remove ice shapes from inserts. In this invention, the releaser is modified to enable cooling of beverages inside drinking vessels. An open-ended reservoir within the modified releaser's body stores ice and other coolants. A hook-like feature permits the attachment of the modified releaser to drinking vessels of varying wall thicknesses. Another ring-like feature with a hollow center holds drinking straws. The state of the fluids contained within the body can be visually monitored through the top opening. This monitoring serves as an indicator of the device's cooling efficiency, especially when ice (or water) is contained.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to frozen materials, for example ice and fill-able materials containing coolants, used to cool beverages inside drinking vessels such as cups. The most common method of cooling beverages outside refrigerators is by introducing ice or frozen plastic materials containing coolants directly into the vessel. Some other methods involve attaching pre-cooled materials around the vessel containing the beverage.

Frozen substances such as ice dilute beverages and increase the liquid volume that requires further cooling. The quality of the water used to make ice may also be a health concern, when consumed along with the beverage. The free-floating characteristic of frozen solid materials may inconvenience those drinkers attempting to avoid their consumption along with the beverage. These frozen objects can become a choking hazard when swallowed.

Frozen substances with ice enclosed can be expected to contain increasing levels of water when utilized outside refrigerators. The solid to liquid phase change results in a mixture containing ice and water within the substance. The close proximity of the relatively warmer water to the ice increases the melting rate. The increased melting rate within the substance renders the beverage cooling process less efficient.

When cooling materials are wrapped around vessels, the exterior shape of the vessel is distorted. This temporary alteration creates an inconvenience in handling the vessel. Also, there is usually a significant delay in obtaining a cold beverage because the cooling material is not in direct fluid contact, which slows down the heat transfer or absorption process.

Eventually pre-cooled and frozen materials lose their ability to further reduce the temperature in their respective vessels. This phase occurs when their temperature rises close to that of the beverage in the vessel. A real time method of determining this phase is usually absent, especially when the coolant is enclosed within a solid material. Several of the existing methods for cooling beverages are described in the patents itemized below.

U.S. patents:

| | |
|---|---|
| 4,325,230 | Driscoll et al |
| 4,843,836 | Childers |
| 5,732,567 | Anderson |
| 6,446,461 | Williams et al |
| 6,523,364 | Pader |
| 6,786,062 | Greenberg |

Canadian patent:

| | |
|---|---|
| 2,031,704 | Spinos et al |

In some cases, retail products have been derived from the listed patents, and are considered an improvement to the direct use of ice in beverages. However, these products possess one or more of the limitations already mentioned. In general, these inventions are either unsuitable or limited when used in drinking vessels, such as cups.

There is therefore a need for an improved beverage cooling device that can be utilized directly in drinking vessels. This device should be user-friendly, practical, and efficient. It should eliminate the drawbacks resulting from ice usage without causing new problems. The present invention may provide one or more of the foregoing advantages or other advantages which will become apparent to persons skilled in the art after review of the present application.

### BRIEF SUMMARY OF THE INVENTION

This invention describes a hollow device (modified Releaser) with multiple functions, made from a metal, plastic or rubber material. The releaser can be used for removing frozen shapes in a freezer tray (previously described in U.S. Pat. No. 6,540,200). When water is added into its reservoir and frozen, the modified releaser may also be used to cool beverages. This additional cooling function takes place when the pre-cooled modified releaser is attached to a vessel containing the beverage. A technique that takes advantage of the unique reservoir shape separates the melted ice (or water) from the frozen ice in the initial cooling stage, thereby increasing the cooling effectiveness. Also by suspending the solid ice formation in the reservoir and allowing the resulting water an easy passage to the bottom portion of the modified releaser, this technique effectively contains the water in the modified releaser during the initial cooling stage. This prevents spillage, or mixing of the water and beverage.

A design feature shaped as a hook permits the attachment of the modified releaser to the inside of vessels such as cups. Another feature, a hollow cylindrical shape which resembles a ring, permits the insertion of a straw through its middle section. The function of this ring-like feature is to hold the object within its center in place.

The top portion of the modified releaser has an open end which exposes the reservoir. When water is added into the reservoir and frozen, the top opening allows easy monitoring of the ice. This visual monitoring provides a real time means of determining the cooling potential of the modified releaser. The cooling effectiveness of the modified releaser diminishes as more ice becomes water which flows to the vacant lower compartment of the reservoir. Initially a reduction in the ice level is observed through the top opening. As the cooling capacity declines further, the increasing water volume serves as the principal indicator.

### BRIEF DESCRIPTION OF THE SEVERAL VIEWS OF THE DRAWING

FIG. 1 is a perspective view of a modified releaser. The area A depicts the hook-like feature used for attachment to the inside of vessels. The sloping edge (B) enables attachment to vessels with varying wall thicknesses.

C shows the hollow cylindrically-shaped feature designed to hold drinking straws that fit through its center.

The arrow D depicts the opening at the top of the modified releaser leading into its reservoir. This reservoir has two distinct sections. The top section or portion is rectangular shaped. This leads through a narrower channel into another portion which has an increasing cross-section, until the bottom closure is reached. The reservoir can be filled with coolants such as water prior to freezing.

The primary modified releaser shown in FIG. 1 can be adapted in several ways.

FIG. 2 illustrates one of such adaptations. In this adaptation, there is a fixed cross-section extending from the opening at the top portion to the bottom portion closure. E depicts a lid for sealable engagement with the top portion. F is a water permeable restraint portion (tray with holes).

In the second adaptation illustrated in FIG. 3, G shows the bottom portion ending with a decreasing cross section.

In the third adaptation shown in FIG. 4, H depicts an engagement means for removably securing the top and bottom portions.

The fourth adaptation, depicted in FIG. 5, has a retractable bottom portion that can be moved from a first position (J) to the second position (I). The volume of the reservoir is greatest when the bottom portion is in the second position.

### DETAILED DESCRIPTION OF THE INVENTION

The modified releaser is a dual function plastic device that is primarily used to remove frozen ice shapes from inserts. This function has been described in U. S. Pat. No. 6,540,200. In this invention, the body of the modified releaser is adapted to become a reservoir. A coolant that solidifies when frozen is added into the reservoir. As a result, the modified releaser may be utilized directly to cool beverages in drinking vessels.

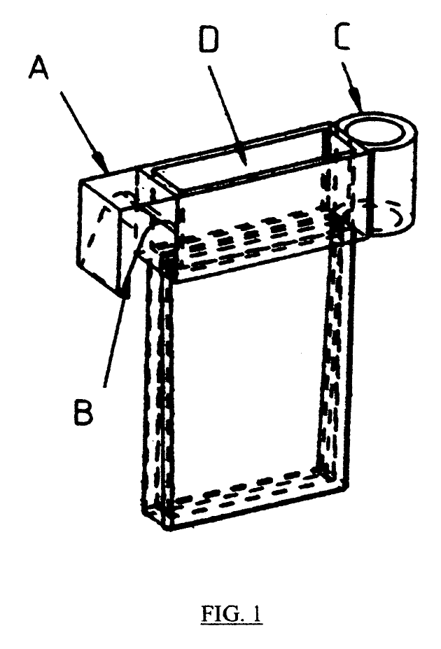

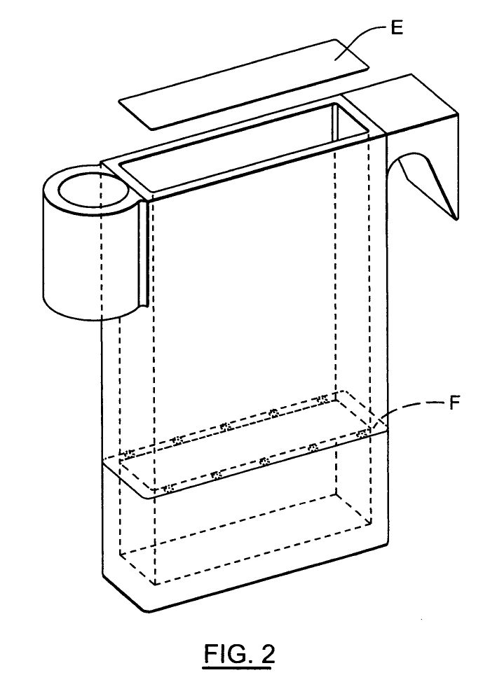

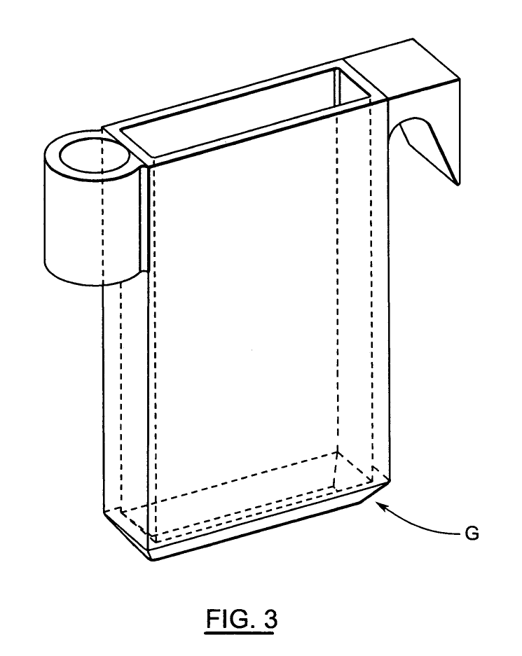

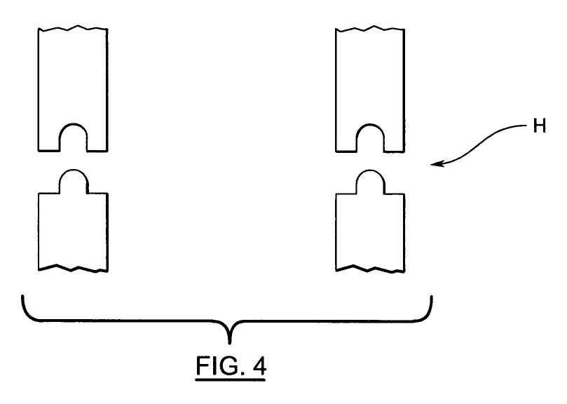

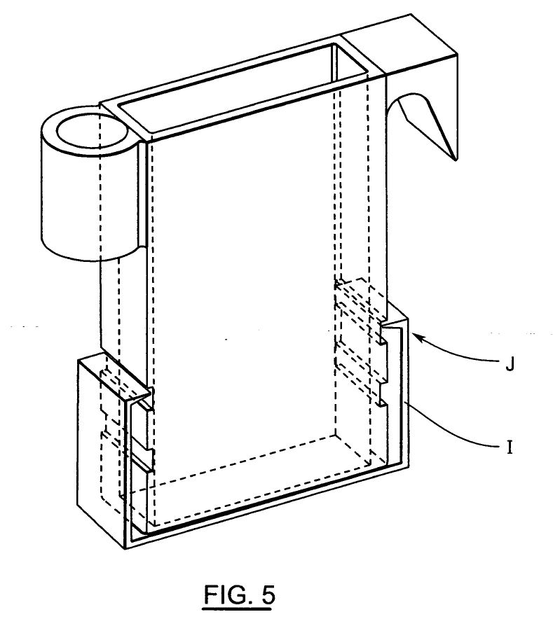

A simple technique is employed to accomplish this objective. First, the desired coolant is added into the reservoir up to about half the level of the top portion (as shown in FIG. 1). A lid (E in FIG. 2) is employed to seal the main opening at the top portion. With the lid in place, the modified releaser is vertically inverted (lid resting on the bottom surface inside the refrigerator) and frozen. Once frozen, the modified releaser is vertically inverted back to the upright position, and the lid removed to expose the reservoir (now containing a frozen coolant).

The aim of this technique is to enable the formation of an air space at the covered end of the bottom portion of the reservoir. As a coolant, for example ice, melts in the upright position, the water resulting from the melting ice at the inside surfaces of the releaser flow by gravity to the bottom thereby gradually displacing the air enclosed.

This technique has three functions. The initial cooling stage is prolonged because the water arising from the melting ice flows to the bottom, while the solid ice is suspended in the reservoir due to its shape. This temporary separation prevents the ice from melting at a faster rate due to contact with the relatively warmer water.

The initial cooling phase can be observed through the top opening (D). It is identified by a shrinking volume of ice and bubbling as water displaces air. As the modified releaser becomes a less effective cooling device, water fills the entire bottom portion of the reservoir and a greater volume of water appears in the top portion. This indicates the need to replace the modified releaser.

The third function of this technique is to retain the water at the bottom portion of the modified releaser for a longer period, thereby avoiding spillage as the drinking vessel is tilted. The modified releaser is ideally functional when in contact with beverages filled to the upper sides of drinking vessels. When drinking a beverage directly without a straw, the tilt of the vessel required for this level of beverage will be lesser than if the beverage is almost entirely consumed. By keeping melted ice/water at the bottom of the modified releaser, this technique ensures that there will be no spillage when the beverage is consumed during the initial cooling stage. The modified releaser(s) can be replaced with fresher ones once the initial cooling stage has expired.

For chilling beverages, the pre-cooled modified releaser is attached to the inside of filled vessels. The hook-like feature (A) enables the attachment of modified releasers to a wide variety of drinking vessels with various shapes and wall thicknesses. The ring-like feature (C) restrains the movement of drinking straws being used for beverage consumption. This feature permits the drinker to handle the vessel conveniently with one hand.

The contents of the reservoir can be viewed through the top portion opening. During usage, the melting process is monitored through this opening. This monitoring enables the drinker to effectively decide on when to change a modified releaser. A regular user will be familiar with the different levels of efficiency. Essentially, the cooling function of the modified releaser has been diminished when the reservoir is mostly full of water.

The primary modified releaser (FIG. 1) that has been described in this section can be adapted in several ways. Although each adaptation may have a few different features, all the modified releasers function in a similar fashion. These adaptations are in essence different methods of separating ice from water. In the first adaptation (FIG. 2), a water permeable restraint portion (F) is utilized to separate ice from water. Water is frozen on one side of the restraint. The second adaptation (FIG. 3) has the bottom portion ending with a decreasing cross section. The decreasing cross sectional area (G) serves as a water permeable ice restraint. In another adaptation (FIG. 4), the water-filled top portion is detached from (using feature H) the vacant bottom portion prior to freezing. These two portions are secured together (using feature H) once frozen, to cool the beverage in a vessel. The fourth adaptation (FIG. 5) has a retractable bottom portion that can be moved from a first position (J) to a second position (I). The device is filled with water and frozen in the first position. A vacant reservoir volume is created when the retractable bottom portion is moved into the second position.

The foregoing are specific examples of certain aspects of the present invention. Many other embodiments, including modifications and variations thereof, are also possible and will become apparent to those skilled in the art upon a review of the invention as described herein. Accordingly, all suitable modifications, variations and equivalents may be resorted to, and such modifications, variations and equivalents are intended to fall within the scope of the invention as described herein and within the scope of the appended claims.

I claim:

1. A beverage cooling device comprising:
a body having
a top portion defining an opening,
a bottom portion defining a reservoir, and
a water permeable restraint portion extending between the top portion and the bottom portion; and
attachment means for detachably securing the body to a vessel, the attachment means positioned adjacent to the top portion of the body.

2. A beverage cooling device comprising:
a body having
a top portion defining an opening of a predetermined cross section, and
a bottom portion defining a reservoir of increasing cross section wherein the minimum cross section is proximate with the top portion and the minimum cross section is less than the predetermined cross section of the top portion; and attachment means for detachably securing the body to a vessel, the attachment means positioned adjacent to the top portion of the body.

3. A beverage cooling device comprising:
a body having
a top portion defining an opening of a predetermined cross section, and
a bottom portion defining a reservoir of decreasing cross section wherein the maximum cross section is proximate with the top portion and the maximum cross section of the reservoir is less than or equal to the predetermined cross section of the top portion; and
attachment means for detachably securing the body to a vessel, the attachment means positioned adjacent to the top portion.

4. A beverage cooling device comprising:
a body having
a top portion defining an opening, and
a retractable bottom portion defining a reservoir of a predetermined volume, the retractable bottom portion moveable between a first position and a second position
wherein the volume of the reservoir is greatest when the retractable bottom portion is in the second position; and
attachment means for detachably securing the body to a vessel, the attachment means positioned adjacent to the top portion.

5. The beverage cooling device of any one of claims 1 to 4 wherein the bottom portion further comprises engagement means for removably securing the bottom portion to the top portion.

6. The beverage cooling device of any one of claims 1 to 5 further comprising a lid dimensioned for sealable engagement with the top portion of the body.

7. The beverage cooling device of any one of claims 1 to 6 further comprising receiving means for maintaining a drinking straw in fluid communication with a beverage, the receiving means positioned adjacent to the top portion.

8. The beverage cooling device of any one of claims 1 to 7 adapted for use with a freezer tray unit, wherein the bottom portion further comprises a section for extending into a freezer tray unit insert slot and the top portion further comprises a grip external to the freezer tray unit insert slot for applying a pressure to remove the section from the freezer tray insert slot.
